(19) United States
(12) Patent Application Publication
(10) Pub. No.: US 2016/0214766 A1
(43) Pub. Date: Jul. 28, 2016

(54) Self Opening Style Bag and Method of Manufacture

(71) Applicant: Gateway Packaging Company, Granite City, IL (US)

(72) Inventors: Robert Tiepelman, High Ridge, MO (US); Bob Gielingh, Edwardsville, IL (US)

(73) Assignee: Gateway Packaging Company, Granite City, IL (US)

(21) Appl. No.: 14/630,186

(22) Filed: Feb. 24, 2015

Related U.S. Application Data
(60) Provisional application No. 62/109,041, filed on Jan. 28, 2015.
(60) Provisional application No. 62/116,403, filed on Feb. 14, 2015.

(51) Int. Cl. B65D 30/08; B65D 30/18; B31B 39/00; B65D 30/20

(52) U.S. Cl. CPC B65D 31/04; B65D 31/10; B65D 31/08; B65D 31/02; B31B 39/00

(57) ABSTRACT

A method of manufacturing a self-opening style bag is disclosed, as well as a bag manufactured via the method, where the bottom of the bag has been sealed via application of a hot melt adhesive during in-line bag manufacturing. The disclosure further includes an SOS bag, including a multi-layered SOS bag, having a front panel, a back panel, and a pair of gussets joining the front and back panels, where the SOS bag has been sealed at the bottom via a hot melt adhesive. In an embodiment, the seal is effected via application of adhesive on a front flap and a back flap, and a folding of the front flap and the back flap together to complete the bottom of the bag.

### PRIORITY CLAIMS

This application claims priority to U.S. Provisional Patent Application No. 62/109,041, filed Jan. 28, 2015, and to U.S. Provisional Patent Application No. 62/116,403, filed Feb. 14, 2015, and to a Canadian Patent Application filed Feb. 13, 2015 (for which a serial number is not available as of the date of this filing), the Canadian filing claiming priority to the '041 provisional.

### FIELD OF THE DISCLOSURE

A new self-opening style bag with a unique bottom seal is disclosed, the bottom seal using hot melt adhesive via a new manufacturing process.

### BACKGROUND

The statements in this section merely provide background information related to the disclosure and do not necessarily constitute prior art.

The prior art includes a bag known as an SOS bag. Opinions differ on what SOS actually abbreviates, though it is commonly considered an abbreviation for Self Opening Style. Other interpretations of SOS include Self Opening Sack, Self Opening Square, and Self Opening Satchel. Regardless, an SOS bag as described herein is generally understood to be a gusseted bag including front and back panels joined by gussets, where the bag may be opened from a flat folded orientation to reveal a flat rectangular bottom. When opened, the gussets may be unfolded and serve as side walls that, in conjunction with the front and back panels of the bag, as well as the flat rectangular bottom, define the structure of the bag. A ubiquitous SOS bag might include, by way of illustrative example, a simple single layer brown paper lunch sack.

In the packaging industry, it is common for the top of the SOS bag to be filled with consumer goods, followed by the closure of the top of the bag. This can be done in a variety of manners, including applying adhesive to the top of the bag and rolling the bag closed to complete a top seal of the bag. In other applications, a reclosure apparatus, such as a resealable zipper profile with complementary interlocking features, for example, may be mounted atop the bag.

Often, depending on the contents inserted into the bag or for other reasons, the SOS bag may be a multi-layered construction where the gussets, panels, and bottom are all constructed of a series of layers of material. This can include an inner plastic film layer that makes contact with the contents of the bag. Typically, where an inner film layer is used in an SOS multi-layered bag, glue must be used to seal the rectangular bottom of the bag. This glue, sometimes referred to as cold glue in the art, requires a cure period to ensure a proper seal. Glue may be applied in line during the SOS bag manufacture. The glue of the prior art is typically a water-based glue that provides a poor absorption, if any at all, to the inner film layer of the SOS bag. The cure time of such glue can be around a week, depending on conditions where the seals are cured, which can cause undesirable delays in processing the bags, and further causes a need for time and space for the bags to be stored while the glue cures.

Prior art SOS bags typically require the in-line application of (typically, white) glue to the bottom of the bag to create the seal. Typical glue in prior art applications includes pressure sensitive adhesive that does not and often cannot absorb into a plastic film or clay paper layer of a bag.

Additionally, it is common in the art for SOS bags to be manufactured in-line such that the bags move down the line in a head first direction. In other words, the bags progress from tube stage down to a bottom seal step while travelling with the open top of the bag going first. The white glue of the prior art may then be applied to the bottom of the bag as it progresses down the line.

### SUMMARY

This section provides a general summary of the disclosure, and is not intended to provide a comprehensive disclosure of its full scope or all of its features.

The disclosure includes a method of manufacturing an SOS bag including the first step of providing a tube of indefinite length of gusseted material, where the tube is substantially flat via an inward folding of the gussets, the tube having a bottom. The tube of indefinite length includes a front panel, a back panel, and a pair of gussets joining the front and back panels. In a second step, the gussets at the bottom of the tube may be inwardly folded flat, and the front panel folded up and back upon itself to create a front flap, while additionally creating a back flap. In an optional step after the second step, the back flap may be cut in the gussets to create squared corners on the back flap. In a third step, hot melt adhesive may be applied in a generally squared U pattern. The hot melt adhesive may be applied via a series of spray nozzles acting in concert through a computer logic control. In a fourth step, the front flap may be folded along a fold line down onto the gussets. In a fifth step, the back flap may be folded up onto the folded front flap and gussets, thus completing the manufacture of the bag.

The disclosure further includes an SOS bag, including a multi-layered SOS bag, having a front panel, a back panel, and a pair of gussets joining the front and back panels, where the SOS bag has been sealed at the bottom via a hot melt adhesive. In an embodiment, the seal is effected via application of adhesive on a front flap and a back flap, and a folding of the front flap and the back flap together to complete the bottom of the bag.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

The drawings described herein are for illustrative purposes only of selected embodiments and not all possible implementations, and are not intended to limit the scope of the present disclosure.

FIG. 1, which shows prior art, is a perspective view of a conventional SOS bag, this bag open and resting upright on its bottom.

FIG. 2, which also shows prior art, is a view of the conventional SOS bag of FIG. 1, this particular view showing the bag folded, with the bottom of the bag visible.

FIG. 3 shows an embodiment of a step of manufacturing the SOS bag of the disclosure, this step including the folding of the front panel and gussets to create a front flap and a back flap.

FIG. 4 shows an embodiment of a step of manufacturing the SOS bag of the disclosure, this step including the folding of the front panel and gussets and further illustrating an embodiment where the back panel has been cut to create a squared back flap.

FIG. 5 shows an embodiment of a step of manufacturing the SOS bag of the disclosure, this step being subsequent to that seen in FIG. 4, where this figure illustrates an embodiment of an adhesive pattern that may be used in the bag manufacturing process.

FIG. 6 shows an embodiment of an adhesive pattern that may be used in the manufacturing process of the SOS bag of the disclosure, this figure in particular showing the adhesive as applied by distinct nozzle applicators on an in-line bag manufacturing machine.

FIG. 7 shows an embodiment of a step of manufacturing the SOS bag of the disclosure, this step being subsequent to that seen in FIG. 5, where this figure illustrates a folding of the front flap onto the back flap.

FIG. 8 shows an embodiment of a step of manufacturing the SOS bag of the disclosure, this step being subsequent to that seen in FIG. 7, where this figure illustrates a folding of the squared back flap onto the folded front flap to complete the bottom of the bag.

FIG. 9 shows an embodiment of a step of manufacturing the SOS bag of the disclosure, this step being subsequent to that seen in FIG. 3, and omitting the step seen in FIG. 4, such that the adhesive pattern used in the manufacturing process varies from that seen in FIG. 5.

Corresponding reference numerals indicate corresponding parts throughout the several views of the drawings.

### DETAILED DESCRIPTION

The following description of various embodiments is merely exemplary in nature and is in no way intended to limit the invention, its application, or its uses. Areas of applicability will become apparent from the description provided herein.

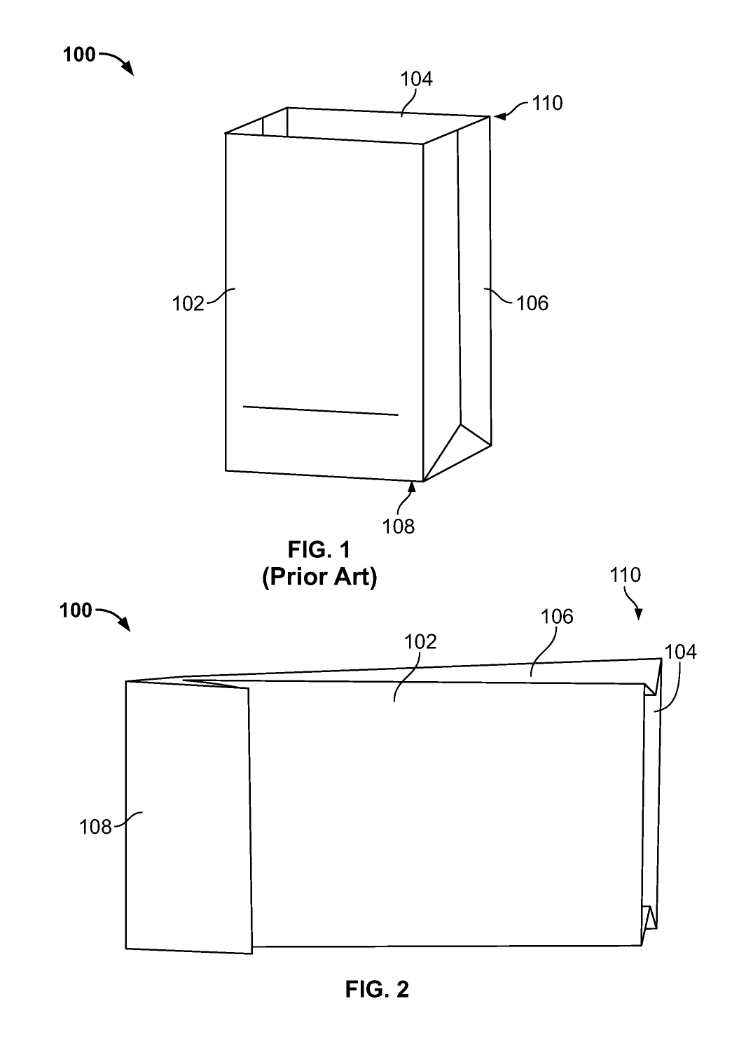

A new SOS bag with a unique bottom seal is disclosed. A typical SOS bag 100, as seen in FIG. 1, includes a front panel 102, a back panel 104, and two gusseted side panels 106 joining the front and back panels, to create a tube having an inside and an outside. A length of tube may be folded and sealed at one end to create a bottom 108, thereby forming an SOS bag. The unfolded end of the tube may be referred to as the top 110 of the bag or the open end of the bag. The SOS bag of FIG. 1 is unfolded and opened upright, while the SOS bag of FIG. 2 is folded flat.

The tube may be constructed of a variety of materials, including but not limited to a multi-layer construction of plastic film on the inner most layer on the inside of the bag. Other layers may include printed paper, such as printed clay coated paper, one or more additional film layers, including an exterior film layer, a kraft paper layer, and a variety of other layers of material known to those of the art in the construction of multi-layered bags. In an embodiment, the bag is a single ply bag.

In one embodiment, the bag is constructed of an inner plastic film layer, where the film may be, for example, oriented polypropylene (OPP), a middle layer of printed paper, where the printed paper may be, for example, a clay coated paper that includes a printed surface facing outwardly on the bag for display to consumers, and an outer film layer, such as a laminated clear plastic film on the printed paper that permits the viewing of the printing on the middle layer even in the presence of an outer layer.

Where the multi-layer construction includes an inner plastic film layer and a middle paper layer, those layers may be adhered together via a hot melt adhesive. Where the multi-layer construction includes an outer plastic film layer and a middle paper layer, those layers may also be adhered together via a hot melt adhesive. Where the SOS bag is multi-layered, the layers may themselves be adhered together in a variety of manners, including a flood coat of hot melt adhesive between the layers.

In an embodiment, a film layer may be adhered to any adjacent layer via laminating the film to said layer. For example, an inner film layer may be laminated to a middle clay coated paper layer, and an outer film layer may be laminated to said middle clay coated paper layer. Beyond these non-limiting examples of bag construction, all other suitable bag constructions are embraced by the disclosure.

Turning to the remainder of the figures, a new method of manufacturing a hot melt sealed bottom SOS bag is disclosed. Additionally, a new hot melt sealed bottom SOS bag is also disclosed.

To manufacture an SOS bag of the disclosure, a tube of bag material may be cut into segments of indefinite length in a bag manufacturing apparatus, or precut segments of tubes may be fed individually into a separate machine. These tube segments may be folded, either prior to or subsequent to cutting into segments, such that the gussets are folded inwardly between the front and back panels. The length of the tube segments and the general dimensions of the bag segments will vary by application.

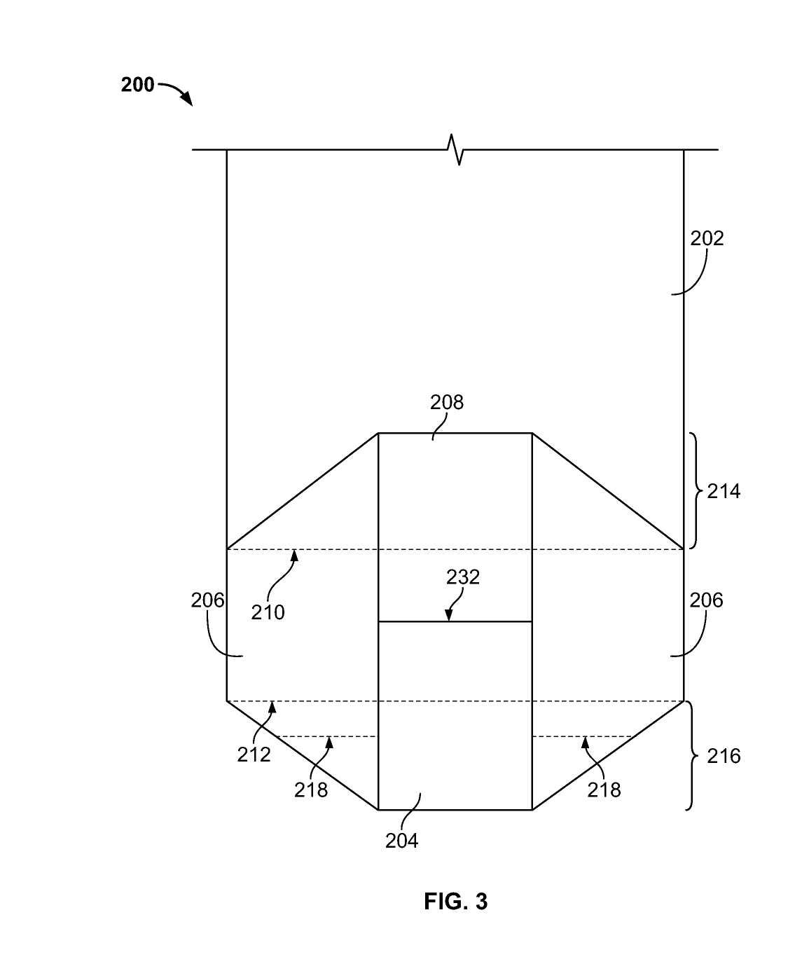

The tube segments of indefinite length 200 may be folded at one end in a first folding step to create the configuration seen in FIG. 3, where the bottom 208 of the front panel 202 has been folded back upon itself and the two gussets 206 have been folded inwardly towards the inside of the tube 200. An unfolded portion of the back panel 204 has been exposed by the folding of the front panel at a crease 232. In so doing, the gussets 206 were first uncreased and flattened below the crease 232 and folded inwardly, prior to the folding back of the front panel 202. This creates the beginning of the distinctive SOS bottom profile.

The bag 200, in later steps as will be seen in subsequent figures, will be folded along a first bottom fold line 210 and then along a second bottom fold line 212, whereby a front flap 214 and a back flap 216 have been created via the fold lines. As will be seen later, the folding of the back flap 216 will overlap the folded front flap 214 which, in conjunction with adhesive, will create a seal along the bottom of the bag.

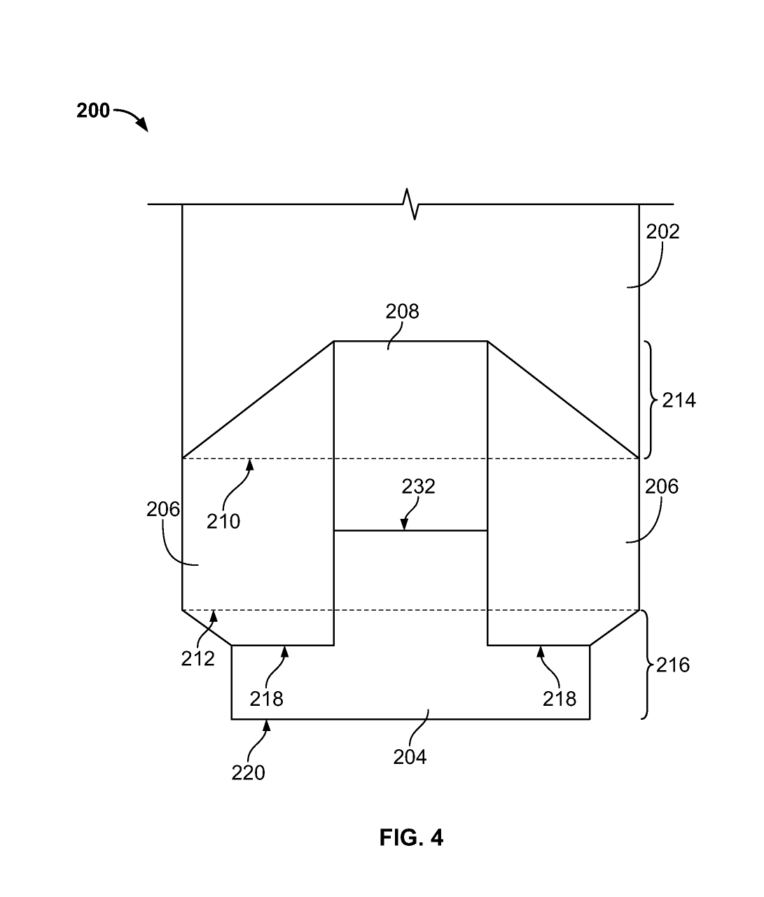

FIG. 3 includes additional detail showing an optional cut 218 that may be made, for example via a slitter assembly on the bag manufacturing line, in the back flap 216, as can be seen further in FIG. 4. FIG. 4 shows the pre-bag tube 200 of FIG. 3, where the optional cuts 218 have been made on the back flap 216 to create a back flap having squared corners 220. The presence of a squared back flap as seen in FIG. 4 permits an enhanced application of adhesive, as will be seen in subsequent figures.

Where the bag 200 is constructed of multiple layers, the optional cuts 218 seen in FIG. 4 may be of one or more layers of the material. For example, where the multi-layered bag includes, from the inside out, an inner plastic film layer, a middle kraft paper layer, and an outer clay coated paper layer, it might be desirable for the cut 218 to only be made on the clay coated paper layer and an outer film layer, while the kraft paper and inner plastic film layers are uncut. Optionally, the cut may also run through the entire construction so that all layers of the bag material are cut to form the squared corners 200 of the back flap 216.

Where the cut 218 is an incomplete cut of the bag material, such that less than all of the layers of a multi-layered bag have been cut, it may be desirable in the earlier construction steps of the bag to selectively omit hot melt adhesive between the layers in certain regions of the material to create glue voids, based upon the eventual dimensions of the bag and flaps, so as to allow easy folding of some layers of the bag while keeping the other unfolded layers that makeup the rounded corners 220 separate. Where the contents of the bag might include foodstuffs in powder form, for example flour or other ground grain or siftable material, having an incomplete cut of a multi-layered bag with an outer film layer may increase the sift-resistant nature of the bottom of the bag, up to potentially a sift-proof bottom.

Optionally, within the two triangular regions of the back flap 216 defined by the cuts 218, regions of glue voids may be present. A glue void is a region between two ply of a multi-layered bag where the layers have selectively not been adhered to one another through the omission of glue in that region. In this instance, where the multi-layered bag is constructed of an inner film layer, a middle clay coated paper layer, and an outer film layer, a glue void in the two triangular regions of the back flap defined by the cuts may enable, for example, the middle clay coated paper layer and the outer film layer to be folded outwardly to form the squared corners 220 while the inner film layer may remain folded upon itself on the back flap, thereby exposing the middle clay coated paper layer to adhesive application in subsequent steps, thereby improving upon the adhesion of that layer to the outer film layer when the back flap is folded.

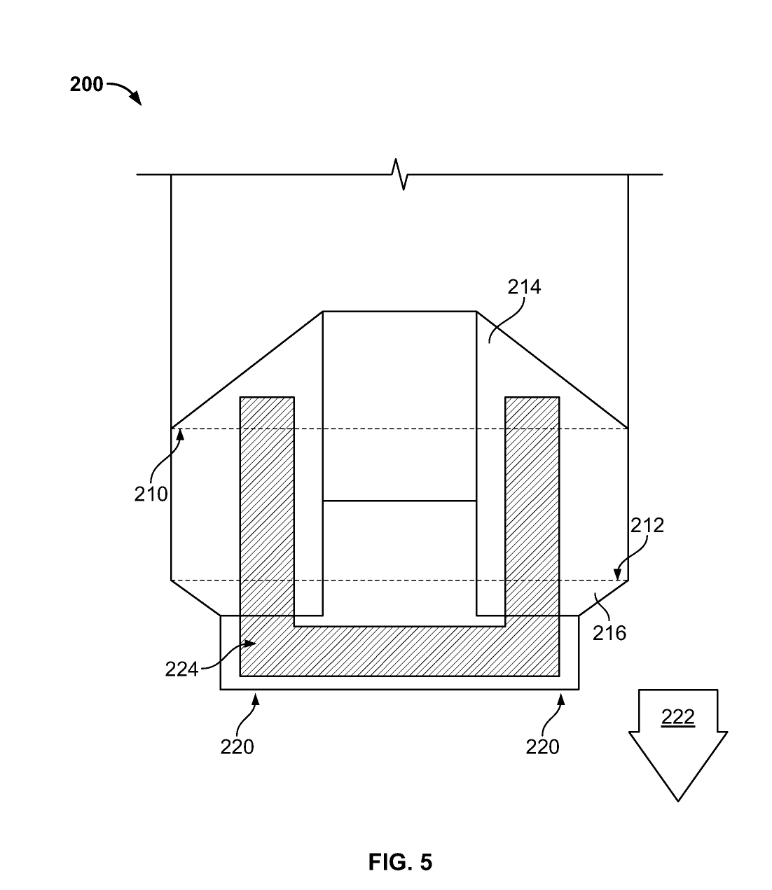

FIG. 5 shows an embodiment of the application of hot melt adhesive 224 in a pattern as the pre-bag tube 200 travels down a path 222. Though the bag is shown travelling down an in-line manufacturing machine bottom first, it should be appreciated that travelling top first down a manufacturing machine is embraced by this disclosure.

As can be seen in FIG. 5, the adhesive pattern 224 in this embodiment is a generally squared U shape that runs linearly between the squared corners 220 of the back flap 216, and then perpendicularly from the ends of the back flap across the gussets 206 and up onto the front flap 214. Upon folding the flaps 214, 216 at their respective folds 210, 212, no adhesive 224 will make contact with any inner portion of the bag, thereby permitting the opening of the SOS bag in a manner seen in FIG. 1. Additionally, all adhesive will be covered by one or more folds of the bag.

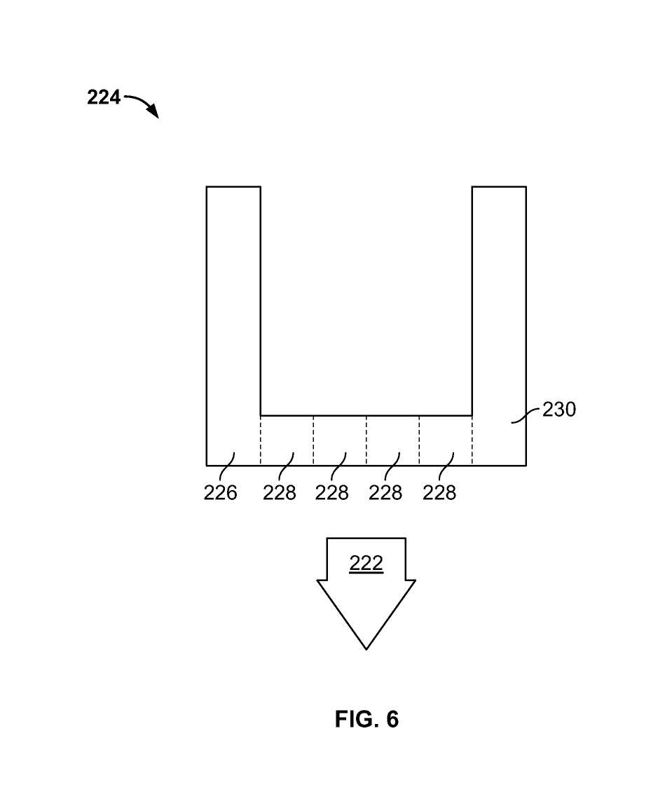

FIG. 6 demonstrates an embodiment of how the hot melt adhesive pattern 224 of FIG. 5 may be achieved. In an embodiment, the hot melt may be sprayed onto the pre-bag tube 200 in a series of parallel sections of varying lengths. As the bag travels down the machine in a direction 222, a series of hot melt adhesive spray nozzles may be configured in series to spray hot melt for pre-determined intervals. In the embodiment of FIG. 6, by way of example only, six spray nozzles have been used, the spray pattern of each nozzle delineated by dashed lines. A first spray pattern 226 represents a long spray of hot melt that runs from one squared corner of the back flap across a gusset and up onto the front flap. Adjacent to that first spray pattern is a series of four relatively brief spray patterns 228 that together provide the linear spray line that runs between the two squared corners of the back flap. A sixth and final spray pattern 230 represents a second long spray of hot melt that runs from the other squared corner of the back flap across the other gusset to the other side of the front flap. In this way, a generally squared U shape as seen in FIG. 5 may be achieved through the use of six spray nozzles in series, where the series is perpendicular to the path 222 of the bag 200 as it is being manufactured.

The spray pattern seen in FIG. 6 is merely exemplary. Additional spray patterns or numbers of nozzles may be employed that vary from the configuration seen in FIG. 6. For example, a narrower bag might employ fewer brief spray patterns 228 between the two longer patterns 226, 230 that bookend those shorter patterns 228.

To achieve proper timing of the spray of the hot melt adhesive on the bottom flaps of the bag as seen in FIG. 5, a variety of mechanisms may be used. In one embodiment, a timing sequence may be programmed into a computer logic that controls the hot melt adhesive spray nozzles such that, referring to the embodiment in FIG. 6, the nozzles that control the first 226 and sixth 230 spray patterns have been programmed to spray for some amount of time, while the intermediate nozzles 228 have been programmed to spray for some briefer amount of time.

In another embodiment, a visual photo recognition system may be used to apply hot melt adhesive to the bag. A computer logic may be programmed to turn on or off certain hot melt nozzles while a camera interfaced with the computer logic monitors the bags as they pass by on the manufacturing machine. The camera may recognize landmarks on the bag, whether structural or printed during an earlier stage of the manufacturing process. In this way, the computer logic will dictate the proper placement of the hot melt adhesive onto the bag by turning on and off each nozzle as the bag passes by the hot melt application apparatus, based on camera recognition of certain features of the bag.

In any event, the speed of the bags as they travel down the manufacturing machine, as well as the spacing of the bags between one another and the dimensions of the bag vis-à-vis the flaps and cuts as seen in FIG. 4, for example, all contribute into the calculation of when and for how long each nozzle sprays hot melt adhesive onto the bag. Those of skill in the art will appreciate that the calculations needed to adjust the computer logic that controls the spray nozzles will vary widely by application and machine, whether the logic sprays based on a pre-set timing or by camera recognition or by some other method. Such calculations are frequently adjusted by those skilled in the art, who may fine tune the timing of the spray nozzles through trial and error test runs of the bag manufacturing process.

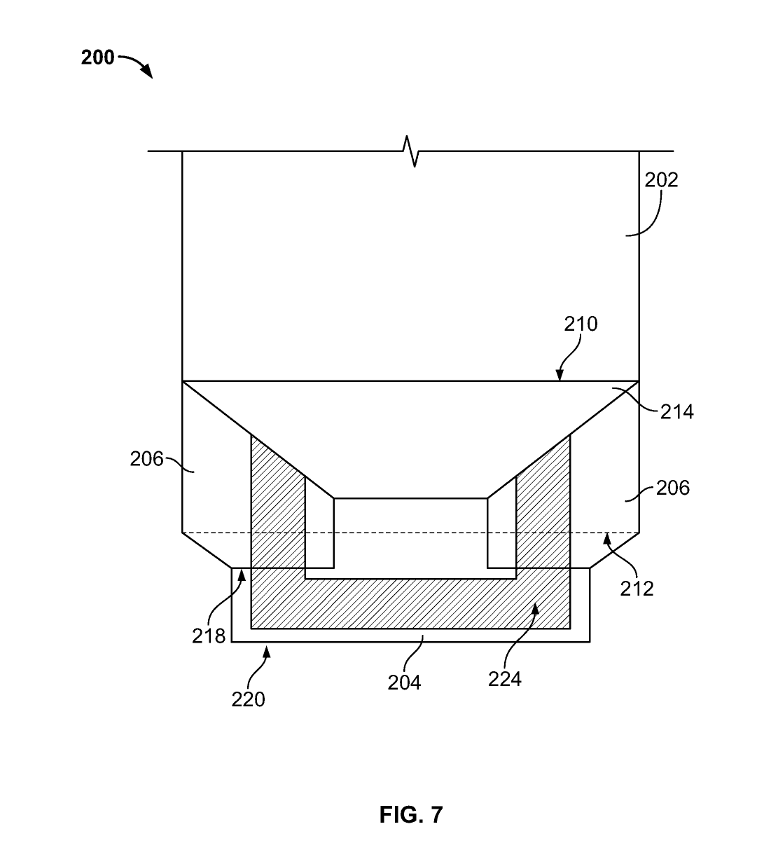

Subsequent to the application of the adhesive 224 to the bottom of the bag 200, a series of folding steps may take place. FIG. 7 demonstrates a first folding step, where the front flap 214 has been folded along its fold 210, over the flattened gussets 206. Because the adhesive was applied to the bottom of the bag across the fold line 210 of the front flap, the folding seen in FIG. 7 creates an at least partial adhesive-to-adhesive seal below the front flap 214. Further, by spraying the adhesive over the fold line 210, the folding of the front flap 214 ensures a complete seal of the bottom of the bag from the fold line towards the back of the bag. Had the adhesive 224 been applied only up to or just before the front fold line 210, the folding of FIG. 7 might result in a bag with an incomplete bottom seal, resulting in possible leakage of the contents of the bag. The folding of FIG. 7 may be achieved through a mechanical step of the in-line bag manufacturing machine.

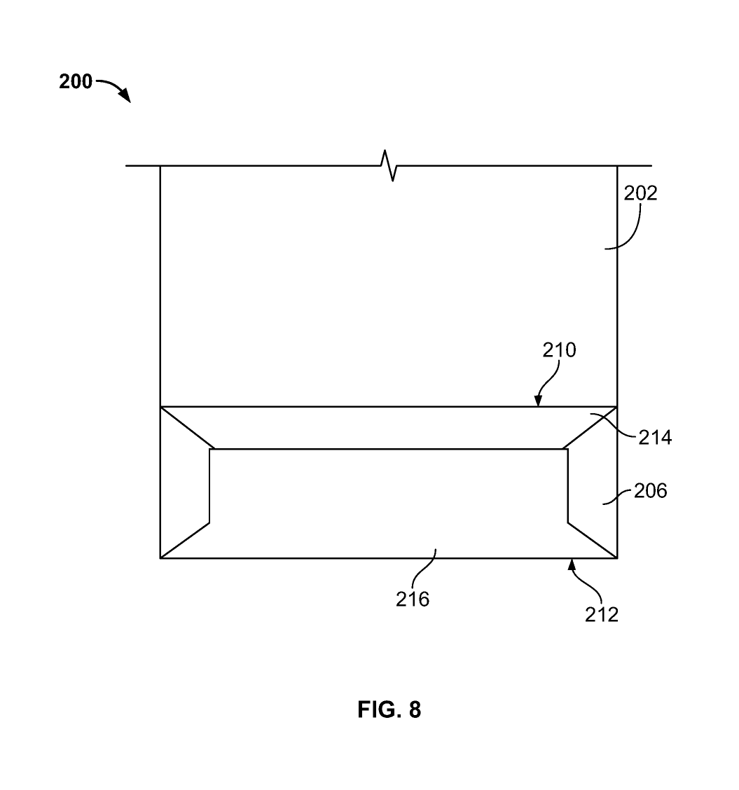

Subsequent to the folding seen in FIG. 7, a second folding of the bottom of the bag 200 is demonstrated in FIG. 8, where the back flap 216 has been folded along the fold line 212 over the front flap 214 and gussets 206 to complete the bottom of the SOS bag. The folding of the back flap completely covers the adhesive that was exposed in FIG. 7.

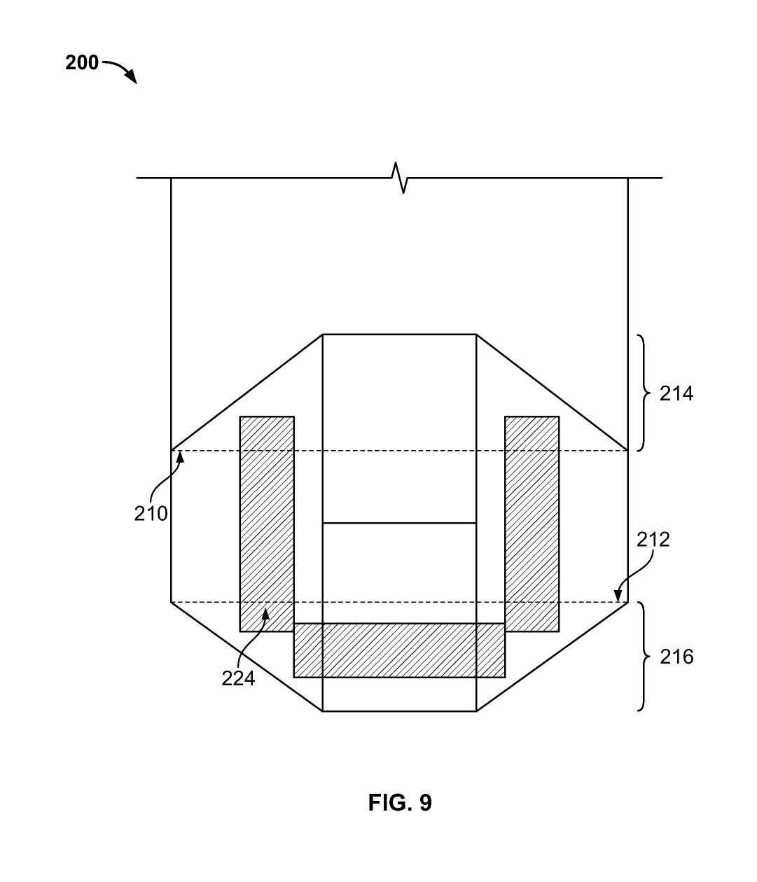

In another embodiment, FIG. 9 a step of manufacturing the SOS bag of the disclosure, this step being subsequent to that seen in FIG. 3, and omitting the step seen in FIG. 4, such that the adhesive pattern used in the manufacturing process varies from that seen in FIG. 5. Where no squared corners 220 of the back flap 216 are present, the hot melt adhesive 224 spray may still be applied to the bottom of the bag. The pattern of spray may be changed by altering the computer logic to create a different pattern for a different bottom bag. In FIG. 9, for example, the adhesive pattern 224 in this embodiment is a general U shape that runs linearly along the back flap 216, and then perpendicularly from the ends of the back flap across the gussets 206 and up onto the front flap 214. Compared to the pattern of FIG. 5, however, the spray does not include full 90 degree corners of adhesive, given the lack of squared corners in this embodiment. Upon folding the flaps 214, 216 at their respective folds 210, 212, no adhesive 224 will make contact with any inner portion of the bag, thereby permitting the opening of the SOS bag in a manner seen in FIG. 1. Additionally, adhesive should be applied such that all adhesive will be covered by one or more folds of the bag, taking particular care in this embodiment given the lack of squared corners to provide a more complete overlap of material when the back flap 216 is folded to complete the bottom of the bag.

Thus the disclosure includes a method of manufacturing an SOS bag including the first step of providing a tube of indefinite length of gusseted material, where the tube is substantially flat via an inward folding of the gussets, the tube having a bottom. The tube of indefinite length includes a front panel, a back panel, and a pair of gussets joining the front and back panels. In a second step, the gussets at the bottom of the tube may be inwardly folded flat, and the front panel folded up and back upon itself to create a front flap, as seen in FIG. 3, while additionally creating a back flap. In an optional step after the second step, the back flap may be cut in the gussets to create squared corners on the back flap. In a third step, hot melt adhesive may be applied in a generally squared U pattern, as can be seen for example in FIGS. 5 and 9. In a fourth step, the front flap may be folded along a fold line down onto the gussets, as can be seen for example in FIG. 7. In a fifth step, the back flap may be folded up onto the folded front flap and gussets, as can be seen for example in FIG. 8, thus completing the manufacture of the bag.

The disclosure also includes a bag manufactured via the aforementioned process.

The disclosure further includes an SOS bag, including a multi-layered SOS bag, having a front panel, a back panel, and a pair of gussets joining the front and back panels, where the SOS bag has been sealed at the bottom via a hot melt adhesive. In an embodiment, the seal is effected via application of adhesive on a front flap and a back flap, and a folding of the front flap and the back flap together to complete the bottom of the bag.

In an embodiment, the bag may be a multi-layered SOS-style bag, where the bag is a tube of material of indefinite length constructed of an inner film layer, a middle clay coated paper layer, and an outer film layer. In this embodiment, the tube may be folded to form a front panel, a back panel, and two gussets therebetween that join the front and back panels. The inner film layer may be adhered to the middle clay coated paper layer in a variety of ways, including through the use of lamination and/or hot melt adhesive or other mechanisms known in the art. Similarly, the outer film layer may be adhered to the middle clay coated paper layer in a variety of ways, including through the use of lamination and/or hot melt adhesive or other mechanisms known in the art. In an embodiment, the clay coated paper layer may include outwardly-facing printing for viewing by consumers, and in such an embodiment it may be desirable for the outer film layer to be of a transparent plastic that is laminated uniformly to the clay coated paper layer.

In this embodiment of the multi-layered SOS-style bag, the bottom of the tube of material of indefinite length may be closed by first folding the front panel back upon itself and folding the two gussets inwardly towards the inside of the tube, as can be seen in FIG. 3. Second, two complementary cuts are made in the back flap to create a back flap having squared corners, as can be seen in FIG. 4. Third, adhesive is applied in a generally squared U shape that runs linearly between the squared corners of the back flap, and then perpendicularly from the ends of the back flap across the gussets and up onto the front flap, as can be seen in FIG. 5. Fourth, the front flap is folded along a fold over the flattened gussets, as can be seen in FIG. 7. And, fifth, the back flap is been folded along a fold over the front flap and gussets to complete the bottom of the SOS bag, as can be seen in FIG. 8, such that all the adhesive has been covered by the folding of the fourth and fifth steps. In an embodiment, the adhesive in this multi-layered SOS-style bag is hot melt adhesive.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention as well as all equivalents thereof.

We claim:

1. A method of manufacturing a bag comprising
in a first step, providing a gusseted tube of indefinite length, the tube having a front panel and a back panel, the front and back panels joined by a pair of gussets, the tube having an open bottom;
in a second step, folding the gussets at the bottom of the tube inwardly and folding the front panel of the bag up and back upon itself to create a front flap, the second step thereby creating a back flap, the back flap having two ends;
in a third step, applying adhesive in a U-shaped pattern to the bottom of the tube such that the adhesive is applied linearly across the back flap and perpendicularly from the ends of the back flap across the gussets and up onto the front flap;
in a fourth step, folding the front flap along a fold line down onto the gussets; and,
in a fifth step, folding the back flap along a fold line up onto the front flap and gussets;
wherein the tube provided in the first step comprises multiple layers, the outermost layer being a plastic film layer.

2. The method of claim 1, wherein the adhesive of the third step is a hot melt adhesive.

3. The method of claim 1, further comprising an additional step between the second and third steps, this additional step comprising a cutting of the gussets to create squared corners on the back flap.

4. The method of claim 3, wherein the adhesive of the third step of claim 1 is applied in a generally squared U shape pattern.

5. The method of claim 2, wherein the adhesive is applied in a series of parallel sections of varying lengths.

6. The method of claim 5, wherein each parallel section of adhesive of varying lengths is applied via a series of hot melt adhesive spray nozzles configured to spray hot melt for individual intervals to achieve the U-shaped pattern.

7. The method of claim 1, wherein the multiple layers of the tube comprise an inner plastic film layer, a middle paper layer, and an outer plastic film layer.

8. The method of claim 7, wherein the inner plastic film layer is oriented polypropylene, the middle paper layer is clay coated paper, and the outer film layer is a clear plastic film.

9. The method of claim 7, wherein the multiple layers of the tube further comprise a kraft paper layer between the inner plastic layer and the middle paper layer, where the middle paper layer is clay coated paper.

10. The method of claim 1, further comprising an additional step between the second and third steps, this additional step comprising a cutting of the gussets to create squared corners on the back flap;
wherein the adhesive of the third step is a hot melt adhesive and is applied in a series of parallel sections of varying lengths to achieve a generally squared U shape pattern.

11. The method of claim 10, wherein the multiple layers of the tube comprise an inner plastic film layer, a middle paper layer, and an outer plastic film layer.

12. The method of claim 11, wherein the inner plastic film layer is oriented polypropylene, the middle paper layer is clay coated paper, and the outer film layer is a clear plastic film.

13. The method of claim 10, wherein the multiple layers of the tube further comprise a kraft paper layer between the inner plastic layer and the middle paper layer, where the middle paper layer is clay coated paper.

14. A multi-layered SOS bag, the bag comprising a front panel, a back panel, and a pair of gussets joining the front and back panels, the bag having a closed bottom, where the closed has been sealed via a hot melt adhesive;
the bag having multiple layers, the outermost layer being a plastic film layer.

15. The bag of claim 14, wherein the seal of the closed bottom of the bag seal has been effected via application of hot melt adhesive on a front flap and a back flap, and a folding of the front flap and the back flap together to complete the bottom of the bag.

16. The bag of claim 15, wherein the multiple layers of the bag comprise an inner plastic film layer, a middle paper layer, and an outer plastic film layer.

17. The bag of claim 16, wherein the inner plastic film layer is oriented polypropylene, the middle paper layer is clay coated paper, and the outer film layer is a clear plastic film.

18. The bag of claim 16, wherein the multiple layers of the tube further comprise a kraft paper layer between the inner plastic layer and the middle paper layer, where the middle paper layer is clay coated paper.

19. A multi-layered bag, where the bag comprises a tube of material of indefinite length, tube comprising a front panel and a back panel, the front and back panels joined by a pair of gussets;
the tube being multi-layered and comprising an inner film layer, a middle paper layer, and an outer film layer, the tube having a closed bottom;
wherein the closed bottom of the tube comprises inwardly folded gussets, a front flap, and a back flap, the back flap comprising squared corners;
the closed bottom further comprising hot melt adhesive adhering the front flap to the folded gussets, and additional adhesive adhering the back flap to the gussets and front flap.

20. The bag of claim 19, wherein the inner plastic film layer is oriented polypropylene, the middle paper layer is clay coated paper, and the outer film layer is a clear plastic film.
